(19) United States
(12) Patent Application Publication
(10) Pub. No.: US 2011/0320494 A1
(43) Pub. Date: Dec. 29, 2011

(54) LITIGATION DOCUMENT MANAGEMENT LINKING UNSTRUCTURED DOCUMENTS WITH BUSINESS OBJECTS

(76) Inventors: Martin Fisher, Heidelberg (DE); Olaf Schmidt, Walldorf (DE)

(21) Appl. No.: 12/824,375

(22) Filed: Jun. 28, 2010

(51) Int. Cl. G06F 17/30

(52) U.S. Cl. 707/780; 707/E17.014

(57) ABSTRACT

According to some embodiments, it may be determined that an unstructured document is associated with a business objected stored at an enterprise resource planning system. Link information identifying the business object in connection with the unstructured document may be stored in a content management system. A litigation matter may then be identified, and an electronic discovery process may be executed across a plurality of object types for the identified litigation matter to identify relevant objects using a rules repository. The electronic discovery process may be, according to some embodiments, operable to automatically discover relationships among a plurality of the relevant objects. It may then be detected that the unstructured document is a relevant object. Based on the link information stored in connection with the unstructured document, it may then be determined that the business object is also a relevant object.

### CROSS-REFERENCE TO RELATED APPLICATIONS

The present application is associated with co-pending U.S. patent application Ser. No. 12/001,048 entitled “Litigation Document Management” filed on Dec. 7, 2007. The entire contents of that application are incorporated herein by reference.

### FIELD

Some embodiments relate to litigation document management. More specifically, some embodiments provide a framework for linking unstructured documents with business objects in connection with litigation document management.

### BACKGROUND

A business or enterprise may be interested in identifying and/or locating electronic documents associated with a litigation matter (e.g., files, emails, word processing files, business objects, or spreadsheets). For example, rules for electronic discovery of documents in civil cases in accordance with the Federal Rules of Civil Procedures (FRCP) address the discovery of electronically stored information (ESI) (also known as eDiscovery), including electronic communication (e.g., emails). These rules generally require organizations to hold pertinent electronic records until each legal matter is formally settled, even when an organization only anticipates litigation. The rules also impose several timelines associated with eDiscovery requirements that can be difficult to meet due to the volume and complexities associated with the electronic documents. Moreover, a lack of compliance can result in significant penalties for companies, legal experts, and executives.

Note that information other than currently active data (or data currently in use by a business) might be relevant to a litigation matter. For example, archive files, backup data, and or attachments might contain information that may be needed to satisfy audits or to respond to the demands of legal discovery processes. Therefore, data that resides in archive files, on backup tapes, and in attachments may need to be considered during the electronic discovery process to fully comply with legal requirements. In some cases, however, archives, backups, and/or attachments may not be designed to be flexibly searched for particular information and the access to data stored in connection with this information might be relatively slow. Moreover, some of the information may be stored as unstructured documents that may be related to one or more business objects, but that relationship might not be readily discernable. In large organizations with a distributed heterogeneous system landscape (e.g., associated with branch offices and/or sub-organizations in various countries), archived data, data on backup tapes, and/or attachments may pose substantial problems in connection with the process of electronic discovery.

Accordingly, a method and mechanism for efficiently identifying and/or locating relevant electronic documents may be provided in accordance with some embodiments described herein.

### BRIEF DESCRIPTION OF THE DRAWINGS

FIG. 1 is a block diagram of a system that might be associated with litigation document management.

FIG. 2 is an example of a system that might be associated with litigation document management in accordance with some embodiments.

FIG. 3 is a flow diagram of a process according to some embodiments.

FIG. 4 illustrates a litigation document management system in accordance with some embodiments described herein.

FIG. 5 is a flow diagram of a process according to some embodiments.

FIG. 6 illustrates an example business environment implementing various features of legal case management within the context of the present inventions.

FIG. 7 illustrates example interfaces between the case management server of FIG. 6 and other local or remote software modules and applications.

FIGS. 8 and 9 illustrate one example configuration of the case manager of FIG. 6.

FIG. 10 is an example of a search performed according to some embodiments.

### DETAILED DESCRIPTION

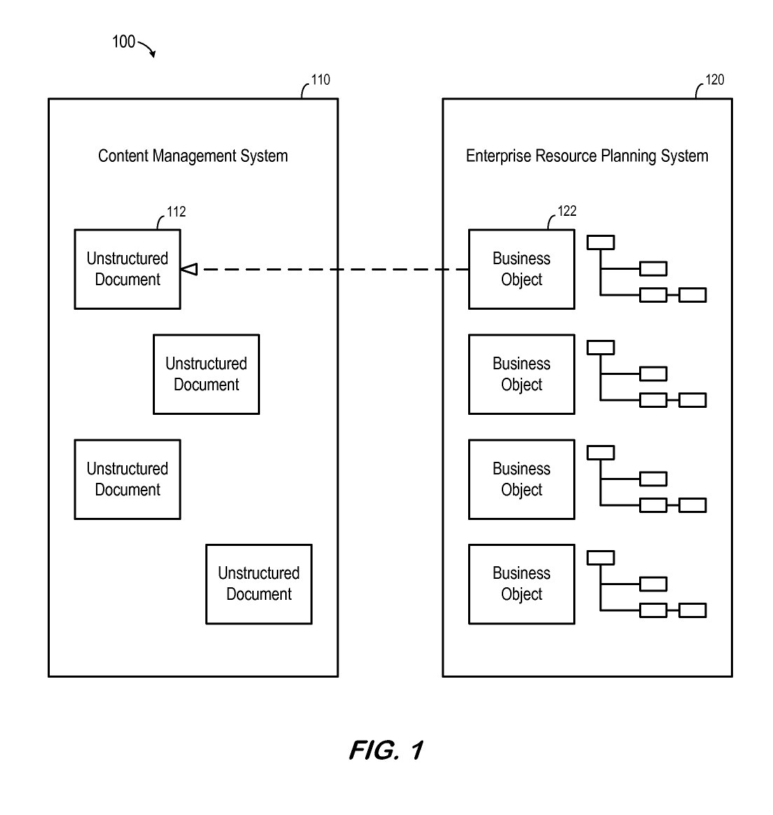

FIG. 1 is a block diagram of a system 100 that might be associated with litigation document management. The system 100 includes a content management system 110 storing unstructured documents 112 and an Enterprise Resource Planning (ERP) system 120 storing structured business objects 122. By way of example, the unstructured documents 112 might be associated with email attachments, spreadsheets, word processing documents, and/or images. As used herein, the phrase “business object” may refer to a set of entities with common characteristics and common behavior representing a defined business semantic. Note that business data may be stored within physical tables of a database. The database may comprise a relational database such as SAP MaxDB, Oracle, Microsoft SQL Server, IBM DB2, Teradata and the like. Alternatively, the ERP system 120 could be associated with a multi-dimensional database, an eXtendable Markup Language (XML) document, or any other structured data storage system. The physical tables may be distributed among several relational databases, dimensional databases, and/or other data sources.

When an enterprise seeks to identify information associated with a litigation matter, it might be determined that a business object 122 is relevant to that litigation matter (e.g., based on a search term or rule). Moreover, it may also be determined that the business object is also linked to an unstructured document 112 (e.g., as illustrated by the dashed arrow in FIG. 1). As a result, both the business object 122 and the associated unstructured document 112 may be flagged as being relevant to the litigation matter (e.g., and a copy of those items might be maintained). If, however, an unstructured document 112 is identified as being relevant to the litigation matter it might not be possible to determine which business objects 122 are associated with that unstructured document 112. Thus, some information relevant to the litigation matter might not be identified by the system 100.

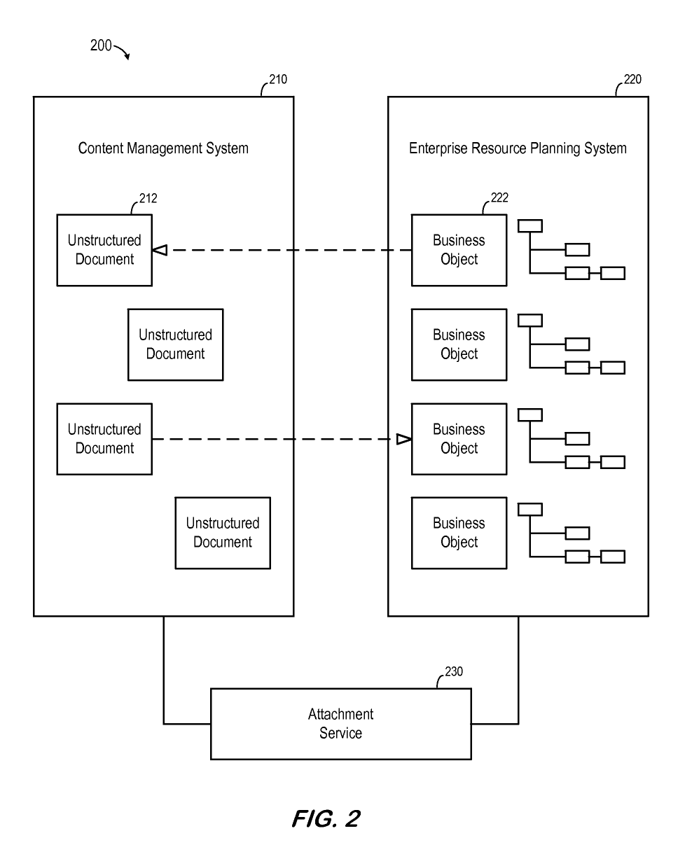

To address this situation, FIG. 2 is an example of a system 200 that might be associated with litigation document management in accordance with some embodiments. As before, the system 200 includes a content management system 210 storing unstructured documents 212 (e.g., email attachments, spreadsheets, word processing documents, or images) and an ERP system 220 storing structured business objects 222. When an enterprise seeks to identify information associated with a litigation matter, it might be determined that a business object 222 is relevant to that litigation matter. It may additionally be determined that the business object 222 is also linked to an unstructured document 212. As a result, both the business object 222 and the associated unstructured document 212 may be flagged as being relevant to the litigation matter (e.g., and a copy of both those items might be maintained).

Moreover, according to some embodiments, an attachment service 230 may be provided to store information linking an unstructured document 212 to one or more business objects 222. As a result, if an unstructured document 212 is identified as being relevant to the litigation matter (e.g., based on a keyword search or other criteria) it will be possible to determine which business objects 122 are associated with that unstructured document 112. Thus, more information relevant to the litigation matter may be identified by the system 200 as compared to the system 100 of FIG. 1.

Note that FIG. 2 represents a logical architecture for describing processes according to some embodiments, and actual implementations may include more or different components arranged in other manners. Moreover, each system described herein may be implemented by any number of devices in communication via any number of other public and/or private networks. Two or more of devices of may be located remote from one another and may communicate with one another via any known manner of network(s) and/or a dedicated connection. Further, each device may comprise any number of hardware and/or software elements suitable to provide the functions described herein as well as any other functions. Other topologies may be used in conjunction with other embodiments.

All systems and processes discussed herein may be embodied in program code stored on one or more computer-readable media. Such media may include, for example, a floppy disk, a CD-ROM, a DVD-ROM, a Zip® disk, magnetic tape, and solid state Random Access Memory (RAM) or Read Only Memory (ROM) storage units. Embodiments are therefore not limited to any specific combination of hardware and software.

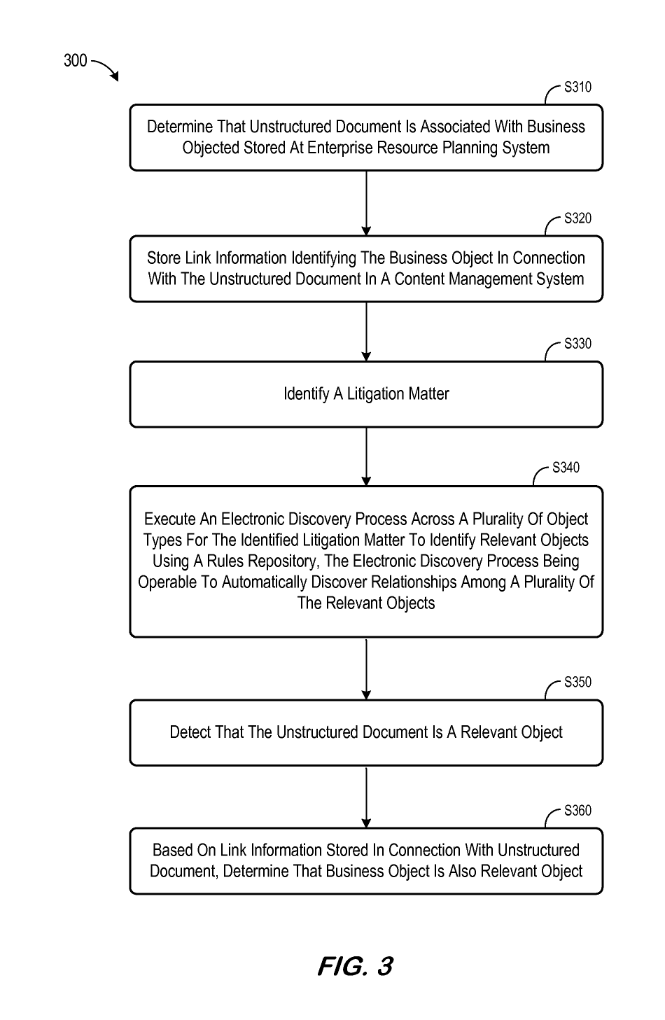

The content management system 210, ERP system 220, and/or attachment service 230 of FIG. 2 may operate in accordance with any of the embodiments described herein. For example, FIG. 3 is a flow diagram of a process 300 according to some embodiments. Note that all processes described herein may be executed by any combination of hardware and/or software. The processes may be embodied in program code stored on a tangible medium and executable by a computer to provide the functions described herein. Further note that the flow charts described herein do not imply a fixed order to the steps, and embodiments of the present invention may be practiced in any order that is practicable.

At S310, it may be determined that an unstructured document is associated with a business objected stored at an ERP system. For example, it might be determined that an attachment to an email message is associated with one or more business objects stored at the ERP system. At S320, link information identifying the business object in connection with the unstructured document is stored in a content management system. For example, an identifier associated with the business object might be stored in the content management system along with the unstructured document.

At S330, a litigation matter may be identified. For example, a case manager or business user might input information identifying the litigation matter. At S340, an electronic discovery process is executed across a plurality of object types for the identified litigation matter to identify relevant objects using a rules repository. Moreover, the electronic discovery process may be operable to automatically discover relationships among a plurality of the relevant objects. For example, the rules repository might indicate that all structured and unstructured documents that include a particular product identifier are related to the identified litigation matter.

At 350, it may be detected that an unstructured document is a relevant object. For example, a spreadsheet that was attached to an email message might be found to include a product identifier. Based on the link information that was stored in connection with the unstructured document at S320, it may then be determined that the business object is also a relevant object at S360. As a result, business objects might be discovered as being relevant to a litigation matter that might have otherwise gone undetected. Once the relevant objects are identified, a legal hold might be placed on at least a first of the relevant objects and information for at least a portion of the relevant objects might be visualized for a user. For example, a tree-type display of the relevant objects might be displayed on a Graphical User Interface (GUI).

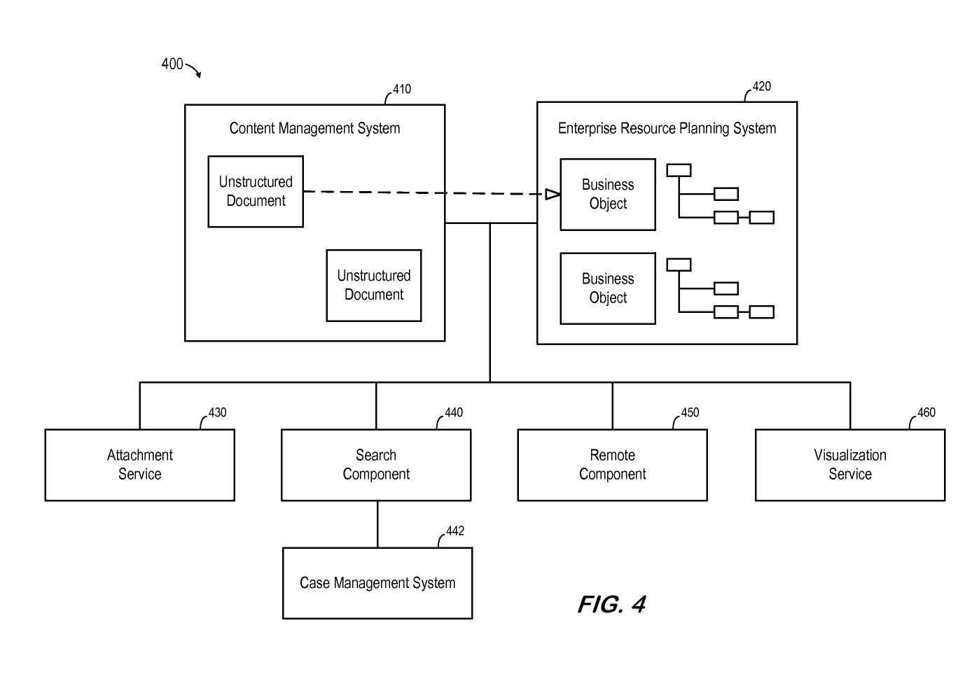

FIG. 4 illustrates a litigation document management system 400 in accordance with some embodiments described herein. As before, the system 400 includes a content management system 410 storing unstructured documents (e.g., email attachments, spreadsheets, word processing documents, or images) and an ERP system 420 storing structured business objects. According to this embodiment, an attachment service 430 stores and maintains information linking unstructured documents in the content management system 410 to the appropriate business objects in the ERP system 420. For example, the content management system 410 may store unstructured data together with defined properties that link to business object information.

When an enterprise seeks to identify information associated with a litigation matter, search terms or rules might be entered via a search component 440. As a result, it might be determined that a business object in the ERP system 420 is relevant to that litigation matter, and that the business object is also linked to an unstructured document. Likewise, when it is determined that an unstructured document is relevant to the litigation matter, information generated by the attachment service 430 may be used to locate one or more business objects that may also be relevant to the litigation matter. In either case, the identified objects may then be flagged in (or copied into) a case management system 442. The system 400 may further include a remote component 450 (e.g., to allow a case manager or business user identify information, including business objects) and/or a visualization service 460 (e.g., to display search results associated with a litigation matter).

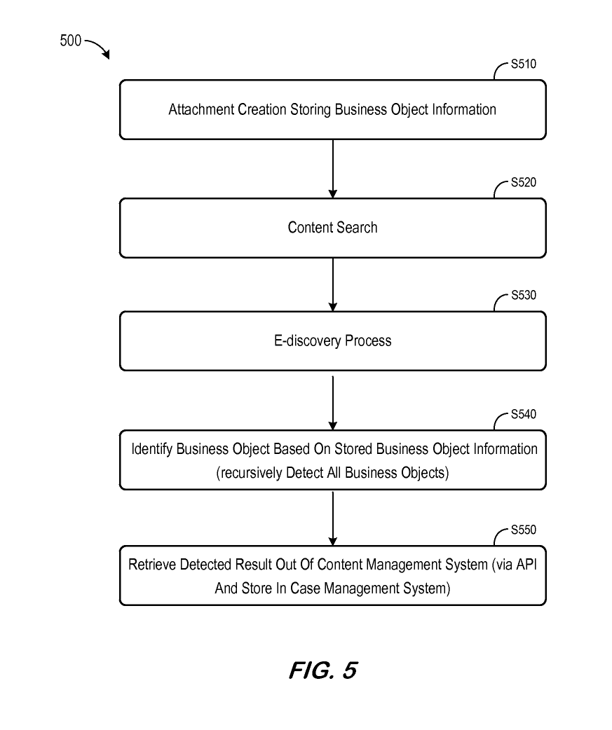

The system 400 may operate in accordance with any of the embodiments described herein. For example, FIG. 5 is a flow diagram of a process 500 according to some embodiments. At S510, an attachment creation process may store business object information. For example, during the creation of attachments to business objects an attachment service may be used to provide business object information (e.g., an object identifier, an object type identifier, and/or an origin system identifier) to a content management system. This information may be stored together with the attachment in the content management system.

At S520, a content search is executed (e.g., via a search user interface). For example, a search user interface might allow legal experts (e.g., attorneys) define e-discovery rules to describe search criteria potentially relevant for legal cases for attachments (e.g., via keywords or attribute values such as a creation and modification time). At S530, an e-discovery process may be executed and return a list of documents meeting the applied e-discovery rules. For every unstructured document that contains business object information (e.g., as identified by an attachment service), a task may be started to collect the appropriate business object and/or process information at S540. The task collecting the business process information may, according to some embodiments, start to identify the business object in the origin system by means of the stored business object information using a remote business object identification interface. Starting with this first business object, a business object relation framework may be triggered to recursively detects all business objects related to each other (resulting in the building the entire business process).

At S550, the detected result sets may be retrieved out of the content management system via an appropriate API. The retrieved data may then be stored in a case management system. Methods may also be provided to view the business processes, the involved business objects, and/or the attachments out of the case management system. As a result, additional data may be detected in an e-discovery process. That is, during the e-discovery process business processes related to attachments may be discovered and considered for a legal hold associated with an anticipated or pending law suit.

Note that any of the embodiments described herein might be associated with, for example, SAP NetWeaver, A1S/AP, SAP Suite, SAP Research, Government Support and Services (GSS) interfaces, Industry Solutions products, or legal case management software. Moreover, embodiments may be used in order to discover information regarding intellectual property and/or to be compliant with rules for electronic discovery of documents in civil cases.

Many of the case management examples provided herein illustrate searches for prior or existing content based on a current search term or rule. Note, however, that embodiments may also or instead support the searching and/or identification of future content based on a current search term or rule. For example, a legal “written opinion” document (e.g., associated with a patent non-infringement letter or legal patent design-around project) may be based on the current technical design of a hardware or software system. If the hardware or software system was to change, however, the written opinion document might need to be revised. In this case, a search term or rule might be entered into a case management system, and all future content meeting that criteria could be automatically flagged. Legal counsel could then review the new content to determine if the prior written opinion document needs to be updated.

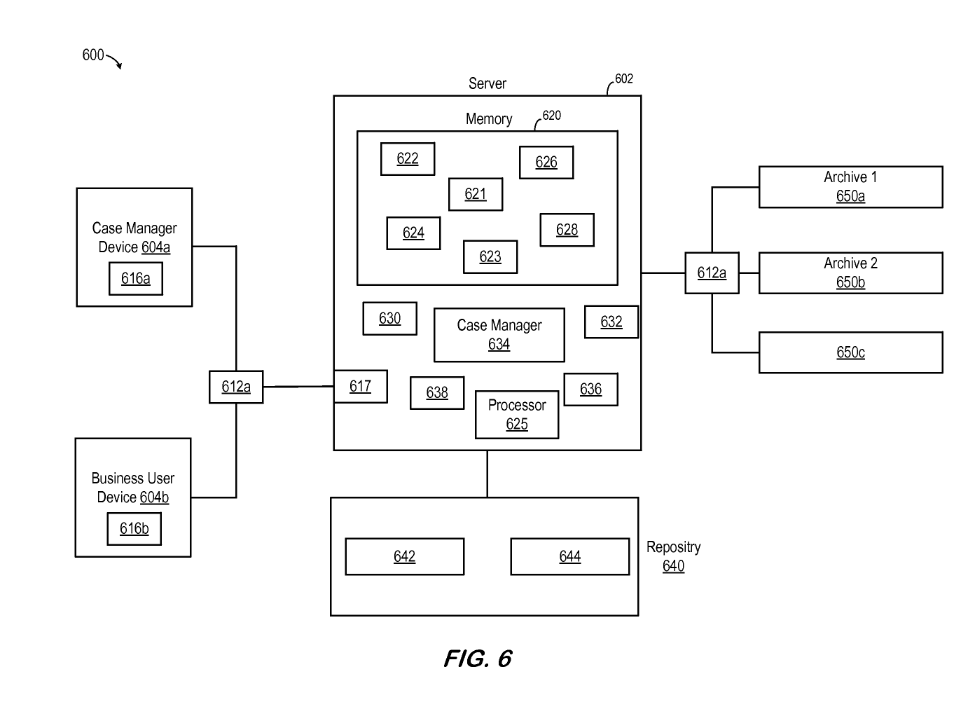

Some embodiments described herein relate to computer systems and methods for case management within a business environment 600 and, more particularly, to methods, systems, and software for creating, facilitating, or otherwise managing legal processes involving business objects, documents, and other (often electronic) transactional data. For example, FIG. 6 illustrates one example business environment 600 that implements a case manager 634 to help ease and automate various case management processes including managing case meta-information, document and business data collection, source code collection, email collection, document holds, and so forth. In general, this case management software 634 might offer an integrated central entry point or portal for the legal discovery process and automatically identify relevant electronic data in distributed system landscapes, including business objects that are linked to unstructured documents (e.g., attachments). More specifically, the case management software 634 might enable a user to consolidate, manage, and/or process information about a complex issue in a central collection point, typically at a case level. Within each case, diverse information (e.g., business objects, electronic documents, email, attachments and so on) may be grouped, even when this information resides in different physical or logical systems. Accordingly, high level tasks of such a software solution could include:

provide a central point for collecting electronic data related to a certain litigation, case, or other legal type matter;

support different types of data (email, business objects, archived data, source code, etc.) across various repositories and repository types (such as different source control systems);

support cooperative work (e.g. ad-hoc workflows);

place or enforce a legal hold on affected electronic documents;

provide various APIs for, among other things: i) legal hold application or enforcement to transactional and inactive data; ii) the lookup of legal hold information; iii) automatic electronic discovery; and iv) rule management;

access management (user authorization and personalization);

identify business objects associated with unstructured data; and

log or audit user actions related to a certain legal hold process.

These example features of the case manager 634 may be utilized to support a company-wide legal hold process (or perhaps even joint defense group-wide in a distributed service-oriented landscape). A legal hold might be considered, for example, a type of “freeze” placed on data objects, often because an organization wishes—or is required to—preserve certain data objects, such as transactional data (whether active or archived) and related documents, associated with a litigation matter. Put another way, the legal hold may be a process by which an organization preserves and prepares disparate forms of electronic data and communication associated with a litigation matter. For example, the case manager 634 can define a special case type “legal hold” for actual or anticipated legal actions (such as lawsuits or administrative proceedings).

Electronic discovery generally refers to a process in which electronic data is located, searched, and secured with the intent of using it as evidence in a lawsuit. In the process of electronic discovery, relevant data of many types can serve as evidence. This can include text, images, calendar files, databases, spreadsheets, audio files, animation and multimedia, web sites, and computer programs and their source code.

Environment 600 is typically a distributed client/server system that spans one or more networks, such as 612, to utilize and communicate electronic data. Put another way, environment 600 may be in a dedicated enterprise environment—across a local area network or subnet—or any other suitable environment without departing from the scope of this disclosure. In some cases, environment 600 represents an organization's accounting, payroll, inventory, development, or some other department that utilizes active or archived business transactional data, such as invoices, journal entries, human resource records, picklists, kit items, checks, and source code. It will be understood that business environment 600 encompasses any environment that includes, stores, or utilizes data—whether active or archived—that is, or could be, the target of a litigation hold or collection process. For example, the business that is associated with business environment 600 may be an enterprise, a non-profit, a home business, a data storage facility, a source code escrow company, and other appropriate entities with potentially relevant data. In fact, environment 600 can further include or be connected to other parties in the electronic discovery and legal process, including law firms, experts, escrow companies, and collection companies.

Turning to the illustrated embodiment, environment 600 includes or is communicably coupled with server 602 and one or more clients 604, at least some of which communicate across network 612. Server 602 comprises an electronic computing device operable to receive, transmit, process and store data associated with environment 600. For example, server 602 may be a Java 7 Platform, Enterprise Edition (J2EE—compliant application server that includes Java technologies such as Enterprise JavaBeans (EJB), J2EE Connector Architecture (JCA), Java Messaging Service (JMS), Java Naming and Directory Interface (JNDI), and Java Database Connectivity (JDBC). But, more generally, FIG. 6 provides merely one example of computers that may be used with the disclosure. Each computer is generally intended to encompass any suitable processing device. For example, although FIG. 6 illustrates one server 602 that may be used with the disclosure, environment 600 may be implemented using computers other than servers, as well as a server pool. Indeed, server 602 may be any computer or processing device such as, for example, a blade server, general purpose personal computer (PC), Macintosh, workstation, Unix-based computer, or any other suitable device. In other words, the present disclosure contemplates computers other than general purpose computers as well as computers without conventional operating systems. Server 602 may be adapted to execute any operating system including Linux, UNIX, Windows Server, or any other suitable operating system. According to one embodiment, server 602 may also include or be communicably coupled with a web server.

Server 602 often includes memory 620. Illustrated memory 620 represents any memory or database module and may take the form of volatile or non-volatile memory including, without limitation, magnetic media, optical media, random access memory (RAM), read-only memory (ROM), removable media, or any other suitable local or remote memory components. Illustrated memory 620 includes case metadata and template 621, lookup table 622, offline repository 623, discovery ruleset 624, profile 626, and one or more relationship graphs 628. But memory 620 may also include any other appropriate data such as HTML files, data classes or object interfaces, unillustrated software applications or sub-systems, and so on. For example, memory 620 may include pointers or other references to one or more lookup tables 622 that are located remote from server 602.

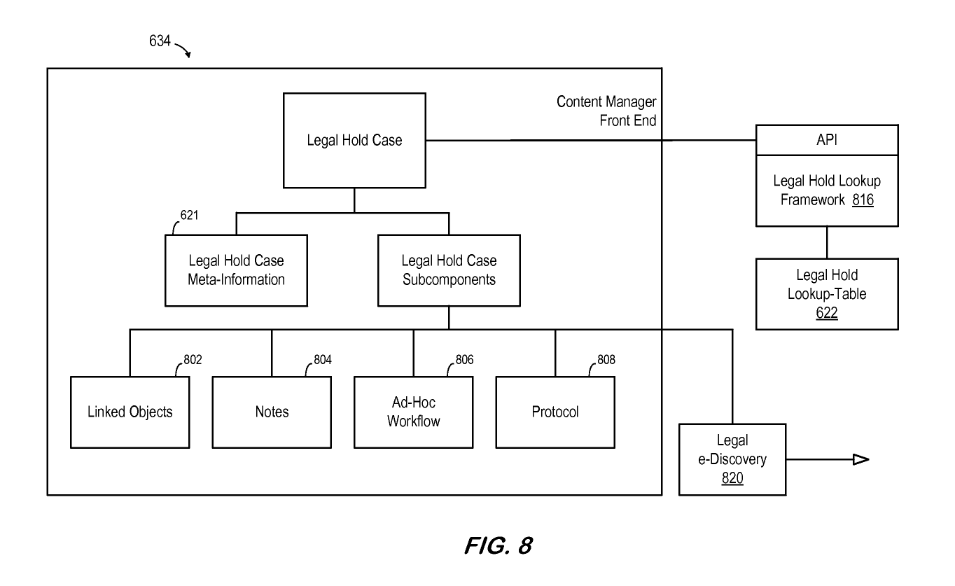

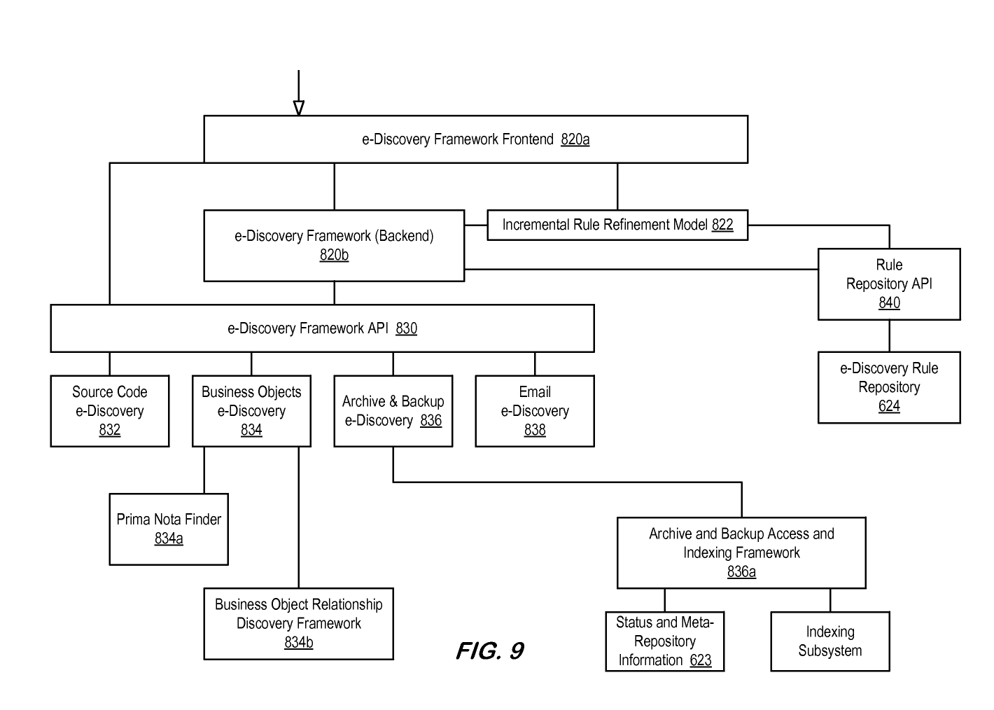

The legal hold case template 621 defines a set of meta-attributes which give detailed information about the context of a legal hold case. These attributes may be utilized for the fast lookup of legal hold cases based on meta-information search. There are two different sets of meta-attributes attached to a legal hold case. Basic meta-attributes that are inherited by legal hold cases (case identifier, creation date, status, and so forth). Legal hold case specific attributes (or customer specific) may be defined when a case of a particular type (such as legal hold) is created. As shown in FIG. 8, several sub-components may be defined for a particular case and provide functionality that supports the legal hold process: linked objects 802 (including links from unstructured documents to business objects of an ERP system), notes 804, ad-hoc workflows 806, electronic discovery 820, and protocol 808. Accordingly, standard sub-components can include linked objects, notes, and log components.

The linked object sub-component of the template of legal hold cases may help define anchor points for data objects of certain types which are relevant for a certain legal hold case (e.g., email, accounting documents, and Microsoft Word documents). In certain instances, only electronic documents of these types are relevant for a specific legal hold process in the context of a legal action, and only data objects of these types may be linked to an instance of a legal hold case. The object types may be defined based on company rules or rules defined in the litigation. In some cases, only the relevant objects are linked to a legal hold case, which helps save time during legal discovery related to a legal hold process and storage costs as well (because objects with a legal hold are not allowed to be deleted/destroyed even if retention time is expired). Notes may be entered to capture legal hold relevant information during the entire processing life of a legal hold case and to facilitate communication between processors. A log component enables a status tracking (or audit) for a legal hold case. While the audited activity may be tailored or configured, all actions related to the legal hold case may be logged in some environments.

A legal hold (or lookup) table 622 may be considered any runtime or non-volatile data structure that allows the retrieval of a reference to an electronic document in a distributed environment based on a unique key for this document. Thus, the legal hold index can be—but is not necessarily—realized as a database lookup table. Both terms refer to electronic data of certain types used in certain contexts.

The system 600 may include or be communicably coupled with (at some point) an offline repository 623 for status- and meta-information related to source code, archives, backup stores, and any other local or third party offline (or non-active) data in a distributed system landscape. Put another way, the offline repository may be considered a destination repository that contains information regarding relevant document repositories and the corresponding connectors to these repositories that are utilized by the electronic discovery framework (email server, external storage system for documents, content management systems, archives, backups, and so forth). Specifically, this repository can maintain, store, or reference unique identifiers for archives/backups and their locations. Meta-information about the location of an archive file, the creation date, the utilized archiving/backup system (vendor) and the record types (structure description of a date object) contained in archive files can also be maintained. In other words, while the archive or backup utility may be active, the data is generally inactive or “offline.” Regardless, offline repository 623 can store information such as archive location (physical and virtual), information type(s), storage type, connector types (JDBC, API, etc.), vendor type (Oracle, Sun, etc.), online vs. offline (active server vs. tape), and so forth.

Based on this information, the framework is able to locate the archive files and backup systems in the network (distributed environment). Additionally the structure of data objects which are contained in archive files and backup stores may be known. When an electronic discovery is planned, it may be decided which information is relevant to the lawsuit (e.g., by defining rules for the lookup process). This repository may also store legal hold information for archive files. As soon as the electronic discovery finds data in an archive file or backup that is relevant for an anticipated or pending litigation a legal hold flag is set. Legal holds may be taken into account before a final delete (destroy) of data is performed. Usually a company has established some kind of policy for information retention in the context of an Information Lifecycle Management (ILM) strategy. Thus, the framework may offer an open interface for requesting legal hold information in regard to archive files and backups. This interface may be utilized by an information retention component. An example record (or other data item) could be: on fileserver <XYZ> the archive file <UVW> was produced by archive system of vendor <ABC> and this archive file contains records describing business objects of type <EFG>. No legal hold is currently defined for any data record in this archive file.

As part of (or utilized concurrently with) archive repository 623, an index may be utilized. The index for existing archives and backups may be built offline. The building process considers certain rules that describe the structure of the index and the data sources (and their locations) for the indexing process. The rules are defined in order to support electronic discovery in the context of various lawsuits, audits, etc. and ensure that the index is filled with the appropriate data. This index may be (relatively) centralized or distributed as appropriate.

In addition to the destination repository 623, the case manager 634 can also utilize a rule/criteria repository 624 for electronic discovery. In the rule/criteria repository 624, the criteria for the identification of relevant documents are maintained. This rule repository is evaluated during the electronic discovery process. These rules are evaluated during the online and offline indexing process. Note, when the company is involved in a lawsuit there might be new rules necessary for the electronic discovery. These rules are defined and stored in a rule repository and an offline indexing process is started which takes into account all new rules. A new archive run considers all active rules and thus the relevant index data is retrieved immediately during the archiving run. A rule contains descriptions relevant information for an electronic discovery (which document types are relevant for the discovery process and which data elements are used for the lookup process). Additionally a mapping of data fields of records in archive files or backup elements to index fields in an index table is defined in these rules. An example rule or record (or other data item) could be:

In the context of a lawsuit <XYZ>, archived documents of type email and Accounting Document business objects are relevant. The electronic discovery process considers data fields <Sender>, <Send-Date>, and <Receiver> of records in the email archive. For archived accounting documents, the data fields <Company-Code>, <Fiscal Year>, and <Posting Period> of the records in the archive files are relevant. Additionally, a mapping of these data fields to the fields of the corresponding index tables may be defined. Note that once new rules are defined (because of a new lawsuit, audit, or other), the central index or decentralized indexes are normally updated accordingly. This is done automatically by the framework once a new rule is defined and persisted in the rule repository. Status information for each rule in the repository can indicate if the current index or indexes are updated according to this rule. As soon as the index/indexes are updated, the electronic discovery utilizes the corresponding rules.

At a high level, the profiles 626 may provide a centralized repository for user-specific and role-specific personalization and authorization data in the context of legal hold management and central access mechanisms to this data for user and role maintenance. In general, personalization is the process of customizing an application or framework to the needs of specific users and groups of users, taking into account their responsibilities in the context of a certain (business) process.

Some or all of the guideline rules 640 and the development guidelines 645 may be stored or referenced in a local or remote development repository. For example, this repository may include parameters, pointers, variables, algorithms, instructions, rules, files, links, or other data for easily providing information associated with or to facilitate modeling of the particular object. More specifically, each repository may be formatted, stored, or defined as various data structures in HTML, PHP (PHP: Hypertext Preprocessor), eXtensible Markup Language (XML) documents, text files, Virtual Storage Access Method (VSAM) files, flat files, Btrieve files, comma-separated-value (CSV) files, internal variables, one or more libraries, or any other format capable of storing or presenting the objects and their respective methods in a hierarchical form, such as a tree with multiple nodes. In short, each repository may comprise one table or file or a plurality of tables or files stored on one computer or across a plurality of computers in any appropriate format as described above. Indeed, some or all of the particular repository may be local or remote without departing from the scope of this disclosure and store any type of appropriate data.

Memory 620 may include, reference, or be coupled with online repository (termed database for simplicity) 640, which generally represents any online data repository that stores or references active transactional or other business data. Put another way, database 640 stores information created, used, or otherwise managed in a business environment or by a business application in various different forms and structures. Such information may include structured data or data objects 642, such as business objects or business process objects. Information created and stored in the business environment or by a business enterprise may also exist in an unstructured format 644. Such unstructured data may be created, stored, managed, and accessed outside of the business application, yet remain pertinent to the user of the application, as well as the business enterprise as a whole. Further, this unstructured data may be logically related to the structured data managed and stored by the business application. According to some embodiments, relationships defining which business objects 642 are related to various elements of the unstructured data 644 are maintained and used to facilitate a eDiscovery process.

In some cases, database 640 includes a database management system and an accessible document repository. Generally, illustrated database system 640 is meant to represent a local or distributed database, warehouse, or other information repository that includes or utilizes various components. The database management system is typically software that manages online data repository 640, performs tasks associated with database management, and/or responds to queries, including storing information in memory 620, searching online data repository 640, generating responses to queries using information in online data repository 640, and numerous other related tasks. For example, database management system 608 may be any database management software such as, for example, a relational database management system, a database management system using flat files or CSV files, an Oracles database, a structured query language (SQL) database, and the like.

In one embodiment, the structured transactional data may comprise business objects 642 resident in a service-oriented architecture. At a high level, the business object 642 is a capsule with an internal hierarchical structure, behavior offered by its operations, and integrity constraints. Business objects 642 are semantically disjointed, i.e., the same business information is represented once. The business object model contains all of the elements in the messages, user interfaces, and engines for these business transactions. Each message represents a business document with structured information. The user interfaces represent the information that the users deal with, such as analytics, reporting, maintaining, or controlling. The engines provide services concerning a specific topic, such as pricing or tax. Semantically related business objects may be grouped into process components that realize a certain business process. The process component exposes its functionality via enterprise services. Process components are part of the business process platform. Defined groups of process components may be deployed individually, where each of these groups is often termed a deployment unit.

From this business object model, various interfaces are derived to accomplish the functionality of the business transaction. Interfaces provide an entry point for components to access the functionality of an application. For example, the interface for a Purchase Order Request provides an entry point for components to access the functionality of a Purchase Order, in particular, to transmit and/or receive a Purchase Order Request. One skilled in the art will recognize that each of these interfaces may be provided, sold, distributed, utilized, or marketed as a separate product or as a major component of a separate product. Alternatively, a group of related interfaces may be provided, sold, distributed, utilized, or marketed as a product or as a major component of a separate product. Because the interfaces are generated from the business object model, the information in the interfaces is consistent, and the interfaces are consistent among the business entities. Such consistency facilitates heterogeneous business entities in cooperating to accomplish the business transaction.

Generally, the business object is a representation of a type of a uniquely identifiable business entity (an object instance) described by a structural model. In the architecture, processes may typically operate on business objects. Business objects represent a specific view of some well-defined business content. In other words, business objects represent content, which a typical business user would expect and understand with little explanation. Business objects are further categorized as business process objects and master data objects. A master data object is an object that encapsulates master data (i.e., data that is valid for a period of time). A business process object, which is the kind of business object generally found in a process component, is an object that encapsulates transactional data (e.g., data that is valid for a point in time). The term “business object” will be used generically to refer to a business process object and a master data object, unless the context indicates otherwise. As usually implemented, business objects are free of redundancies.

In some cases, unstructured data 644 may be considered “active” information that is not currently associated with a specific structure within the particular portion of business application 630. More specifically, system 600 often includes (or otherwise references) unstructured data 644 that can include flat files, attachments, faxes, spreadsheets, graphical elements, design drawings, slide presentations, text documents, mail messages, webpages, source code, or other files. In particular, structured data may be considered unstructured data 644 if it is analyzed without its metadata or outside the context of the particular application, database, or process. For example, an application can generate an unstructured element based on structured data. In another example, a database can export or archive more structured database records into unstructured data elements 644. Moreover, an active process may not recognize the structure of an unrelated (or unknown) structured element 642 and process it as an unstructured element 644. According to some embodiments, links from unstructured data elements 644 to appropriate structured elements 6424 are maintained.

Server 602 includes one or more processors 625. The processor 625 may be a Central Processing Unit (CPU), a blade, an Application Specific Integrated

Circuit (ASIC), or a Field-Programmable Gate Array (FPGA). The processor 625 may execute instructions and manipulate data to perform the operations of server 602. Although FIG. 6 illustrates one processor 625 in server 602, only one or more than one processor may be used according to particular needs or desires of environment 600. In the illustrated embodiment, processor 625 executes or interfaces with executing development tool (or environment) 630, business application 632, case manager 634, Information Retention Manager (IRM) 636, and email server 638.

Various portions of case manager 634 may offer interfaces (or APIs) for use by the use of the development environment 630. Generally, the development environment 630 may be any development tool, toolkit, application, or other framework that allows a developer to develop, configure, and utilize data and software objects to develop software solutions or portions thereof. For example, the designer or developer may utilize an integrated development environment (IDE), which is computer software that enables computer programmers to develop other software, such as ABAP and others. In other cases, the development environment 630 may be a workbench or other studio product that allows the developer to graphically or manually code portions of an enterprise software solution within environment 600.

At a high level, business application 632 may represent any application, program, module, process, or other software that may execute, change, delete, generate, or otherwise manage business information according to the present disclosure. In certain cases, environment 600 may implement a composite application 632. For example, portions of the composite application may be implemented as Enterprise Java Beans (EJBs) or design-time components, and may have the ability to generate run-time implementations in different platforms, such as J2EE (Java 7 Platform, Enterprise Edition), ABAP (Advanced Business Application Programming) objects, Service Oriented Architecture (SOA), or some other platform.

Further, while illustrated as internal to server 602, one or more processes associated with business application 632 may be stored, referenced, or executed remotely. For example, a portion of application 632 may be a web service that is remotely called, while another portion of application 632 may be an interface object bundled for processing at remote client 604. Moreover, application 632 may be a child or sub-module of another software module or enterprise application (not illustrated) without departing from the scope of this disclosure. Additionally, in some instances, application 632 may be a hosted solution that allows multiple parties in different portions of the process to perform the respective processing. For example, client 604 may access business application 632 on server 660, or even as a hosted application located over network 620, without departing from the scope of this disclosure. In another example, portions of business application 632 may be used by an authorized user working directly at server 660, as well as remotely at client 604. In yet another example, business application 632 may be hosted by a third party entity for use by a remote client 604 authorized by the taxpaying entity. Regardless of the particular implementation, “software” may include software, firmware, wired or programmed hardware, or any combination thereof as appropriate. Indeed, each software component may be fully or partially written or described in any appropriate computer language including C, C++, Java, Visual Basic, assembler, Perl, any suitable version of 4GL, as well as others.

More specifically, business application 632 may be a composite application, or an application built on other applications, that includes an Object Access Layer (OAL) and a service layer. In this example, business application 632 may execute or provide a number of application services such as Customer Relationship Management (CRM) systems, Human Resources Management (HRM) systems, Financial Management (FM) systems, Project Management (PM) systems, Knowledge Management (KM) systems, and/or electronic file and mail systems.

Information retention manager 636 generally encompasses software that implements one or more document or information retention policies. For example, an information retention management application 636 may include an Archive Session Manager (ASM), an interface to case manager 634, a Destruction Manager (DM), an Information Retention Manager (IRM), and/or an Information Retention Executioner (IRE). According to one implementation, the DM communicates with the IRE to cause one or more business objects 642 and any associated attachments 644 to be destroyed, such as at the conclusion of the retention period. The IRM may initiate archiving by, for example, executing one or more retention time rules to identify one or more business objects according, for example, to properties of the business objects. IRE executes retention properties associated with the business objects 642 as a result of the execution of the retention time rules. The IRE may also function to transfer business objects identified by the IRM from a primary system to a long-term storage system as described herein. Case manager 634 can communicate with the IRE to help ensure a hold, such as the legal hold described herein, to one or more business objects 642 and any associated attachments 644. The ASM may be used to call the IRM to initiate the archiving process. The archiving process may begin when the business objects 642 are queried and one or more of the business objects 642 are identified and assigned an expiration date.

Server 602 may also include interface 617 for communicating with other computer systems, such as clients 604, over network 612 in a client-server or other distributed environment. In certain embodiments, server 602 receives data from internal or external senders through interface 617 for storage in memory 620 and/or processing by processor 625. Generally, interface 617 comprises logic encoded in software and/or hardware in a suitable combination and operable to communicate with network 612. More specifically, interface 617 may comprise software supporting one or more communications protocols associated with communications network 612 or hardware operable to communicate physical signals. Interface 617 may allow communications across network 612 via a Virtual Private Network (VPN), SSH (Secure Shell) tunnel, or other secure network connection.

The network 612 facilitates wireless and/or wired communication between the server 602 and any other local or remote computer, such as the clients 604. Indeed, while illustrated as two networks, 612a and 612b respectively, network 612 may be a continuous network without departing from the scope of this disclosure, so long as at least a portion of network 612 may facilitate communications between senders and recipients of requests and results.

FIG. 6 illustrates three offline storage media or archives 650. Offline storage media 650 may take the form of an optical storage device, such as a CD-ROM or DVD, or may be a tape or other magnetic storage device, or any other appropriate device for the storage of electronic data. Although illustrated in FIG. 6 as separate from server 602 and communicably coupled through an interface, offline storage media 650 may, in some cases, reside on server 602 or be communicably coupled to server 602. In fact, in some cases, offline storage media 650 may be integral to server 602. For example, first archive 650a may represent a local archive that stores inactive or unstructured data. This local archive may include a document repository, fast search index, and other information storage solutions. The second archive 650b may represent a third party solution, whether onsite or not, that stores certain archived or backup data. The final example, archive 650c, can represent a backup tape or other portable media.

The client 604 may any computing device operable to connect or communicate with server 602 or network 612 using any communication link. At a high level, each client 604 can include or execute GUI 616 and comprises an electronic computing device operable to receive, transmit, process and store any appropriate data associated with environment 600, typically via one or more applications such as case manager 634, development environment 630, or business application 632. It will be understood that there may be any number of clients 604 communicably coupled to server 602. Further, “client 604,” “manager,” and “user” may be used interchangeably as appropriate without departing from the scope of the present invention. Moreover, for ease of illustration, each client 604 is described in terms of being used by one user. For example, the respective client 604 could be used by an in-house lawyer, remote outside counsel, paralegals, case managers, business users, and so forth. As used in this disclosure, client 604 is intended to encompass a personal computer, touch screen terminal, workstation, network computer, kiosk, wireless data port, smart phone, Personal Data Assistant (PDA), one or more processors within these or other devices, or any other suitable processing device.

GUI 616 comprises a graphical user interface operable to allow the user of client 604 to interface with at least a portion of environment 600 for any suitable purpose, such as viewing application, modeling, or hierarchical data. Generally, GUI 616 provides the particular user with an efficient and user-friendly presentation of data provided by or communicated within environment 600. More specifically, GUI 616 may be the front-end of case manager 634 or include various interfaces representing such management. For example, GUI 616 may provide an interface for updating the status information in the central status repository. In another example, GUI 616 may present an interface for inserting new rules or updating existing rules in the rule repository and requesting rules from the rule repository. In yet another example, GUI 616 may present a query interface for the electronic discovery process in archives, backup stores, and attachments. This may be a generic user interface as well as a software interface that may be used by third-party applications to utilize the query functionality of the framework.

In some cases, GUI 616 may comprise a web browser that includes a plurality of customizable frames or views having interactive fields, pull-down lists, and buttons operated by the user. For example, GUI 616 is operable to display certain presentation elements, such as wiki pages and links, in a user-friendly form based on what the user, or developer, is trying to accomplish. GUI 616 may also present a plurality of portals or dashboards. For example, GUI 616 may display a portal that allows developers or information managers to view, create, and manage guideline rules 640.

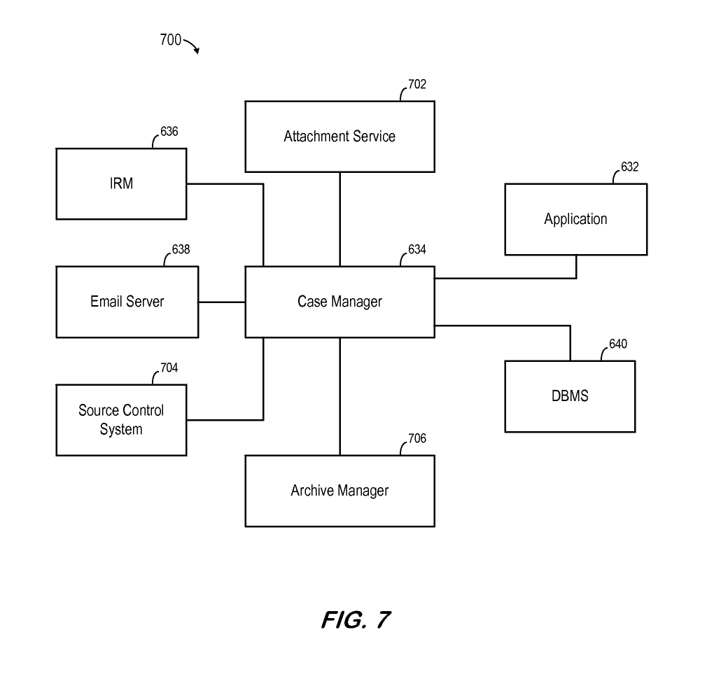

FIG. 7 illustrates example interfaces between the case manager 634 and other local or remote software modules and applications to identify, collect, enforce or confirm legal holds on, or otherwise manage or facilitate management of active and inactive data in terms of a litigation matter, audit, or other case within the context of this disclosure. Specifically, in this example, case manager 634 communicates (via APIs, interfaces or user exits, services, messages, or other communication channels) with business application 632, database management system (or active data repository) 640, one or more backup or archival systems 706, one or more source control systems 704 such as Concurrent Versions System (CVS), an email server 638, an information retention manager 636, and/or an attachment service 702.

FIG. 8 illustrates one example configuration of the case manager 634. It will be understood that while this software is shown as multiple modules that implement the various features and functionality through various objects, methods, or other processes, the features and functionality of various components may be combined into single components as appropriate. Moreover, other local or remote modules or processes could be used alternatively or as a complement to the illustrated configuration. Indeed, in various situations, one or more of the example modules or frameworks may exist alone. For example, a certain system may implement the legal hold functionality without implementing the source code processing. In another example, a system may implement or utilize the object relationship framework to automatically determine relationships between heterogeneous objects (perhaps cross-application or cross-system) outside the litigation or legal hold context.

The legal hold lookup framework 816 may manage legal hold indexes for legal hold information related to electronic documents or business objects stored in a distributed system landscape of a large organization. The framework 816 may be able to handle many types of electronic data due to an infrastructure of open interfaces which support the integration of new document types and business objects. In some circumstances, electronic documents or business objects are identified by unique keys of different formats (the structure of unique keys for documents in the repository of a CMS is different from the structure of a unique key of an accounting document in an ERP-system). Thus, the legal hold lookup framework 816 may offer mechanisms to handle unique keys of different structures.

In certain implementations, the legal hold lookup framework 816 offers various APIs to other applications/services to determine if the particular business object or other data object is subject to a legal hold. APIs may be operable to connect to lookup table 622, determine if object is subject to hold (check), set legal hold, case information requests, release legal hold/delete from lookup table 622, and object type integration API. For example, the framework may include an object type integration API that supports the integration of new document types.

The legal electronic discovery module 820 may be integrated as a subcomponent into the case manager 634. In certain implementations, the eDiscovery module 820 primarily includes two parts, a visual UI 820a and a connector to a generic eDiscovery framework 820b, which can offer an API set 830. The visual UI supports the configuration of a litigation specific eDiscovery process by selecting certain document types from list of all supported document types. The selected document types are presented in a visual subcomponent of the legal hold case in an appropriate way (e.g., a tree view).

In certain implementations, the electronic discovery module 820 may include various sub-modules or process such as source code eDiscovery 832, business object eDiscovery 834 (which can identify business objects based on links from unstructured documents), archive eDiscovery 836, and email eDiscovery. Generally, source code eDiscovery 832 is a central access point to a plurality of source repositories/control systems 704. To help accomplish this, source code eDiscovery 832 may include the connectors to the disparate systems, as well as a parser to allow for easier searching. This module may be capable of searching according to versions, dates, key words, modules, and any other suitable criteria. Once located, source code eDiscovery 832 may hold specific versions of source code that require the developers to start development in new version. Source code eDiscovery 832 can also search and hold related source control system comments as appropriate.

The eDiscovery framework 830 also typically includes or executes a business object eDiscovery module 834. Generally, this module is responsible for identifying or collecting the various structured data, such as business objects 642. Often, this functionality utilizes rules 624 (criteria) for discovery of the business objects 642. These criteria describe business objects 642 that are or might be relevant for a legal hold or document collection in the context of an actual or an anticipated litigation. The rules or criteria may be defined according to company-wide guidelines or special guidelines for specific types of lawsuits related to certain topics (such as tax laws, intellectual properties, and so on). More specifically, this module a) supports the process finding related business objects in a generic and automated way, b) help manage legal hold information for this structured data, and c) provides an API for requesting legal hold information related to certain business objects. According to some embodiments, the eDiscovery module 834 further locates business objects based on links from unstructured documents (e.g., attachments)

To this end, the business object eDiscovery module 834 may also include a prima nota finder 834a to more easily identify a “root” or source business object (or other active data element) and a business object framework 834b that creates a graphical representation of relations between various types of business objects in an ERP landscape. Specifically, this framework 834b, perhaps using a simple callback function, creates a graph taking a target business object as the root node, then the branches to the related business objects. The framework 834b determines directly linked objects for each of these initial objects and so on. This is generally a recursive process that is continued until no new object (and thus no new relation) may be added to the set of discovered business objects. Cycles may be automatically detected during the discovery process. The graph can span system boundaries (and vendor software). This graph is typically instance-based (e.g., a specific instance of data, one PO or one vendor location) and not generic. In some cases, the framework may also generate a graph data structure (set of nodes, set of edges that connects nodes) from the discovered information. If desired, the calculated information about the discovered document relations can then be persisted graph repository 628 for later offline processing. In some instances, the framework may ignore the technical business objects (business objects that are only used within the system) for simplicity and to keep graph from becoming too complex.

Case manager 634 may also offer an archiving module 836. At a high level, the archiving module 836 can build or use a central index by using the information stored in the central repository for status and meta-information). The connected archives and backup stores are scanned by the framework and the index is built according to the rules stored in the rules repository by extracting the relevant data from the archives/backups. In this approach, connectors for various archiving/backup systems are integrated into a framework (or usable by the framework). The framework helps define a generic interface for an archive and a backup connector. This interface contains methods for the sequential scanning of archives/backups, the data extraction from archives/backups and publishing the record structure of data items in the archive/backup store.

It will be understood that FIG. 8 is merely an example configuration of one software solution that offers select functionality of the described case manager 634. In other words, none, some, all, or other modules may be used so long as the appropriate functionality is implemented or achieved. Accordingly, regardless of the particular hardware or software architecture used, environment 600 is generally capable of managing information retention and collection in a litigation context and facilitating litigation document processes and techniques. The following descriptions of the flowcharts focus on the operation of case manager 634 in performing the respective method. But system 600 contemplates using any appropriate combination and arrangement of logical elements implementing some or all of the described functionality. For example, some of the processing or other techniques may be implemented by business application 630 or information retention manager 636 (or some other invoked or referenced libraries or sub-modules not illustrated) working in conjunction with case manager 634.

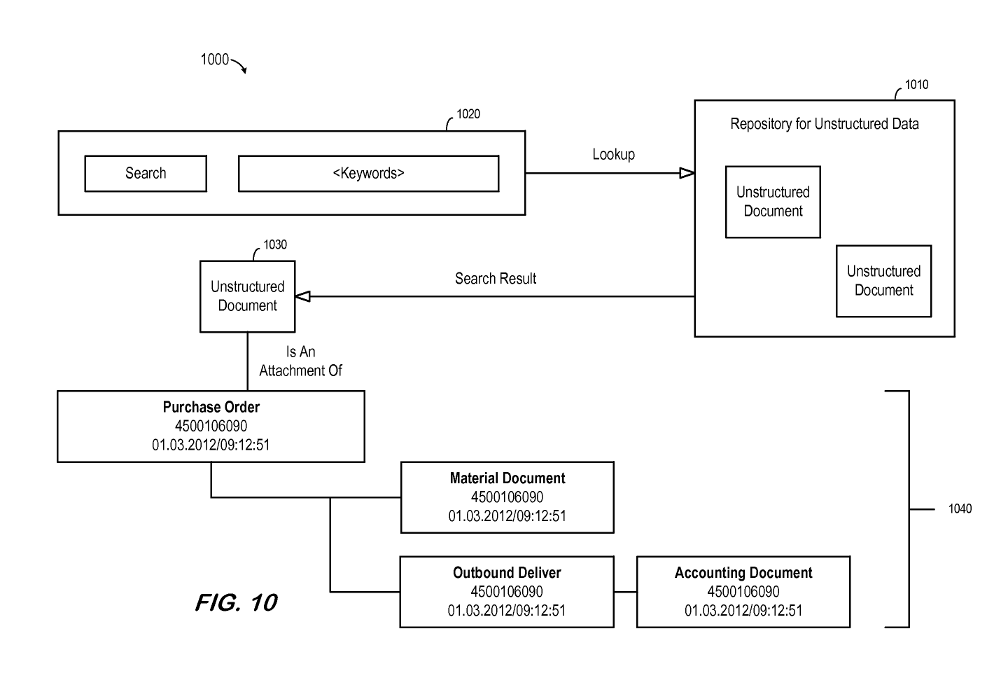

FIG. 10 is an example 1000 of a search performed according to some embodiments. According to this example 1000, a repository for unstructured data 1010 includes a number of unstructured documents. A search 1020 is input (e.g., a keyword might be entered) and a lookup is performed in the repository 1010. A search result is generated and an unstructured document 1030 is output (e.g., because it contains the keyword entered in the search 1020).

Attachment information may then be retrieved from an attachment service and then be used to identify one or more structured business objects 1040 associated with the unstructured document 1030. Note that relationships between business objects might be discovered within an ERP system by using a relationship finder framework as described herein.

The embodiments described herein are solely for the purpose of illustration. Those in the art will recognize other embodiments may be practiced with modifications and alterations limited only by the claims.

What is claimed is:

1. A computer implemented method, comprising:
determining that an unstructured document is associated with a business objected stored at an enterprise resource planning system;
storing link information identifying the business object in connection with the unstructured document in a content management system;
identifying a litigation matter;
executing an electronic discovery process across a plurality of object types for the identified litigation matter to identify relevant objects using a rules repository, the electronic discovery process being operable to automatically discover relationships among a plurality of the relevant objects;
detecting that the unstructured document is a relevant object; and
based on the link information stored in connection with the unstructured document, determining that the business object is also a relevant object.

2. The method of claim 1, wherein the unstructured document comprises an attachment to an email message.

3. The method of claim 2, further comprising:
placing a legal hold on at least a first of the relevant objects; and
visualizing information for at least a portion of the relevant objects.

4. The method of claim 3, wherein the link information includes at least one of: (i) an object identifier, (ii) an object type identifier, and/or (iii) an origin system identifier.

5. The method of claim 3, wherein information associated with at least a portion of the relevant objects is stored in a lookup table.

6. The method of claim 5, wherein the stored information comprises information for parent objects and the lookup table stores data defining relationships between the relevant objects and parent objects.

7. The method of claim 5, wherein an application programming interface (API) enables access to the lookup table by one or more remote applications.

8. The method of claim 3, wherein the litigation matter identified through a user interface is associated with a case type and a unique identifier.

9. The method of claim 8, wherein the electronic discovery process using rules associated with the case type from the rules repository.

10. The method of claim 3, wherein the object types comprise at least a subset of business object, archive data, document, e-mail, and source code.

11. The method of claim 3, wherein the visualized information is presented through an interface and filtered based on a personalization rule.

12. The method of claim 3, wherein the visualized information comprises a tree view of at least one of the relationships.

13. The method of claim 3, wherein software comprises an electronic discovery framework communicably coupled with the rules repository, a legal hold framework communicably coupled with the lookup table, and a front-end for visualizing the information.

14. The method of claim 13, wherein the electronic discovery framework includes an archive module, a source code module, a business object module, and an e-mail module.

15. The method of claim 14, wherein each framework is associated with a plurality of application programming interfaces (APIs) exposed for use by a plurality of applications.

16. A computer-readable medium storing program code executable by a computer to:
determine that an unstructured document is associated with a business objected stored at an enterprise resource planning system;
store link information identifying the business object in connection with the unstructured document in a content management system;
identify a litigation matter;
execute an electronic discovery process across a plurality of object types for the identified litigation matter to identify relevant objects using a rules repository, the electronic discovery process being operable to automatically discover relationships among a plurality of the relevant objects;
detect that the unstructured document is a relevant object; and
based on the link information stored in connection with the unstructured document, determine that the business object is also a relevant object.

17. The medium of claim 16, wherein the unstructured document comprises an attachment to an email message and execution of the instructions further cause the processor to:
place a legal hold on at least a first of the relevant objects; and
visualize information for at least a portion of the relevant objects.

18. The medium of claim 17, wherein the link information includes at least one of: (i) an object identifier, (ii) an object type identifier, and/or (iii) an origin system identifier.

19. A system, comprising:
an enterprise resource planning system storing business objects;
a content management system storing unstructured documents; and
and attachment service to:
determine that an unstructured document is associated with a business objected stored at an enterprise resource planning system, and
store link information identifying the business object in connection with the unstructured document in a content management system.

20. The system of claim 19, further comprising:
a search component to receive a search element associated with a litigation matter, identify a first unstructured document based on the search element, and identify a first business object based on the first unstructured document and associated information generated by the attachment service.

21. The system of claim 20, further comprising:
a visualization service to provide search results associated with the litigation matter to a user
